(19) United States
(12) Patent Application Publication
(10) Pub. No.: US 2005/0224600 A1
(43) Pub. Date: Oct. 13, 2005

(54) Fuel injection apparatus for internal combustion engines, with nozzle needles that can be actuated directly

(76) Inventors: Achim Brenk, Kaempfelbach (DE); Martin Kropp, Tamm (DE); Hans-Christoph Magel, Pfullingen (DE)

Correspondence Address: RONALD E. GREIGG;GREIGG & GREIGG P.L.L.C., Suite One, 1423 Powhatan Street, Alexandria, VA, 22314, US

(21) Appl. No.: 11/101,478

(22) Filed: Apr. 8, 2005

(30) Foreign Application Priority Data
Apr. 8, 2004 (DE) 10 2004 017 305.2

(51) Int. Cl. F02M 47/02

(52) U.S. Cl. 239/88

(57) ABSTRACT

A fuel injection apparatus having a fuel injector fed by a high-pressure fuel source and having an injection valve with injection nozzles associated with coaxial inner and outer nozzle needles can be actuated in a pressure-dependent manner to open and close various injection cross sections at the injection nozzles. A pressure surface of the outer nozzle needle is associated with a closing chamber. To actuate the outer nozzle needle, a first on/off valve can connect the closing chamber to a low-pressure/return system. The inner nozzle needle has a control piston whose pressure surface protrudes into a second control chamber, and a second on/off valve is can connect the control chamber to the low-pressure/return system so that when the second on/off valve is actuated, the pressure is relieved in the second control chamber. This permits a separate actuation of the outer nozzle needle and inner nozzle needle.

### BACKGROUND OF THE INVENTION

1. Field of the Invention

The invention relates to an improved fuel injection apparatus for internal combustion engines.

2. Description of the Prior Art

A fuel injector, which has two rows of injection nozzle holes that are associated with an inner nozzle needle and an outer nozzle needle that is positioned coaxial to the inner one, is known, for example, from DE 102 05 970 A1. Injection nozzles of this kind, which can be actuated in a pressure-dependent manner to open various injection cross sections, are also referred to as vario-nozzles. The outer and inner nozzle needles are each associated with a control piston that acts on a respective fuel-filled hydraulic chamber so that the hydraulic chambers function as actively operating control chambers. The two control chambers are hydraulically connected to each other via a connecting conduit. The control chamber of the outer nozzle needle can be connected to a low-pressure return system via an outlet throttle. The connecting conduit is dimensioned so that when the outlet throttle opens, the pressure first drops in the control chamber of the outer nozzle needle and then, only after a delay, does the pressure drop in the control chamber of the inner nozzle needle.

In order to increase the injection pressure, which is greater than the pressure level prevailing in the pressure accumulator (common rail), DE 102 29 417 A1 has disclosed a fuel injection apparatus that has a pressure boosting unit and, to further improve injection characteristics and increase efficiency, is also equipped with a vario-nozzle that has an inner and an outer nozzle needle. Spring assistance sets the opening pressure of the inner nozzle needle to a constant level and, with the aid of an additional assisting pressure, sets a particular ratio of rail pressure to opening pressure. This makes it possible to adapt the hydraulic flow through the fuel injector to the load point of the internal combustion engine. The inner nozzle needle is set so that it only opens at relatively high pressures of for example greater than 1500 bar in order to thus achieve favorable emissions levels in the partial load range of the engine. The setting of the constant opening pressure for the inner nozzle needle here is very tolerance-sensitive since the opening of the inner nozzle needle is accompanied by a jump in the injection quantity. In this connection, manufacturing tolerances can result in a particularly unpleasant feel. In the other variants for achieving the opening pressure of the inner nozzle needle by means of the constant ratio between the assistance pressure and the nozzle pressure, the inner nozzle needle also opens in the partial load range of the engine.

In order to prevent the tolerances in the duration of the control valve actuation from affecting the injection quantity in fuel injection apparatuses equipped with pressure boosters, the prior DE patent application 102 29 415.1 has already proposed damping the opening speed of an individual nozzle needle without impairing a rapid closing of the nozzle needle. A damping piston is axially guided in the closing chamber of the nozzle needle, delimits a damping chamber, and communicates with the closing chamber of the nozzle needle via an overflow conduit.

### OBJECT AND SUMMARY OF THE INVENTION

The object of the present invention is to further improve the adaptability of the fuel injection apparatus to the operating points of the internal combustion engine and to meet the demand for a homogeneous combustion process.

The fuel injection apparatus according to the present invention has the advantage of permitting an improved adaptation of the duration and volume of the injection to the operating point of the internal combustion engine. A first on/off valve is provided to actuate the outer nozzle needle and a second on/off valve is provided to actuate the inner nozzle needle. The first on/off valve can connect a closing chamber for the outer nozzle needle to a low-pressure/return system. In order to actuate the inner nozzle needle, the second on/off valve can connect a control chamber associated with the first nozzle needle to the low-pressure/return system so as to relieve the pressure in the control chamber. This permits a separate actuation of the outer and inner nozzle needles so that the two nozzle needles of the vario-nozzle can be activated independently of each other. As a result, the quantity or volume injected by means of the two rows of injection nozzle holes can be varied in that from one injection to the next, it is possible to freely select from among an injection via the first row of holes, the second row of holes, or both rows of holes together. It is also possible to freely select between the injection pressure level with pressure boosting and without it.

The entry direction of the injection jet into the combustion chamber, which is produced by the inclination of the nozzle bore and is also referred to as the vertical angle, influences not only the pressure and the injection angle, but also the combustion process of the engine. If the two rows of holes of the nozzle bores for the injection nozzles are provided with different inclinations and/or spray cones, then there is the potential, by means of the separately actuatable rows of holes, of working with different vertical angles so that with a very small vertical angle, a homogeneous combustion with an early injection onset can be achieved without wetting the cylinder wall of the engine. Since homogeneous combustion processes can only be used for certain engine loads, the flexible injection with different vertical angles or spray angles also offers the possibility of an optimal adaptation to different combustion concepts.

Advantageous improvements and updates of the invention are disclosed. The filling of the control chamber from the rail pressure system can be suitably provided via a throttle or a check valve; the check valve prevents the control chamber from emptying into the control line.

The fact that the two nozzle needles can be actuated independently of each other permits this actuation concept to be used in a particularly suitable fashion in so-called leakless injector nozzles in which a separate fuel supply is provided for the inner injection nozzles. The separate fuel supply leads from a nozzle chamber associated with the outer nozzle needle to a pressure shoulder on the inner nozzle needle upstream of the inner injection nozzle. The separate fuel supply line is thus suitably embodied as an intermediate chamber between the inner nozzle needle and the outer nozzle needle. A rapid closing of the outer nozzle needle is achieved if a dividing line is provided between the end surface of the outer nozzle needle and an associated damping piston inside a closing chamber and in addition, there is a hydraulic connection between the damping chamber and the closing chamber.

In a particularly suitable embodiment, it is also possible to combine the independent actuation of the two nozzle needles of the vario-nozzle with a pressure boosting unit that is integrated into the fuel injector.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 shows a schematic representation of a first exemplary embodiment of a fuel injection apparatus according to the present invention,

FIG. 2 shows a schematic representation of a second exemplary embodiment of a fuel injection apparatus according to the present invention,

FIG. 3 shows a schematic representation of a third exemplary embodiment of a fuel injection apparatus according to the present invention, and

FIG. 4 shows a schematic representation of a fourth exemplary embodiment of a fuel injection apparatus according to the present invention.

### DESCRIPTION OF THE PREFERRED EMBODIMENTS

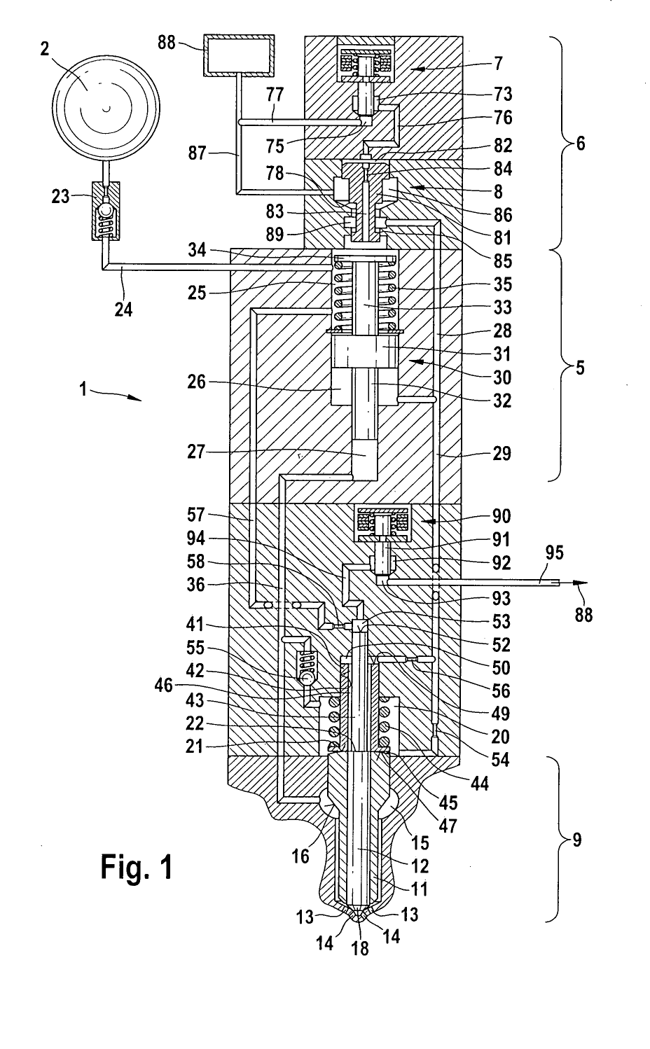

The fuel injection apparatuses shown in FIGS. 1 through 4 include a fuel injector 1 and a high-pressure accumulator 2 (common rail); the high-pressure accumulator 2 supplies highly pressurized fuel to the fuel injector 1. The fuel injector 1 includes a pressure booster 5, a servo-valve 6, and an injection valve 9 whose combustion chamber end injects fuel into a combustion chamber, not shown, of an internal combustion engine. The servo-valve 6, which is embodied for example in the form of a 3/2-way valve, has a first on/off valve 7 and a control valve 8 actuated by it. In the present exemplary embodiment, an electromagnet actuates the on/off valve 7. However, a piezoelectric actuator can also take the place of the electromagnet. In other embodiment forms for the servo-valve 6, it is also possible to use a directly-controlled solenoid valve or a pressure-balanced 3/2-way valve with a piezoelectric actuator.

The injection valve 9 has a vario-nozzle with an outer nozzle needle 11 and an inner nozzle needle 12. The nozzle needles 11, 12 are guided coaxially one inside the other and can move longitudinally independently of each other. The vario-nozzle has two rows of injection nozzle holes, with outer injection nozzles 13 and inner injection nozzles 14; the outer nozzle needle 11 is associated with the outer injection nozzles 13 and the inner nozzle needle 12 is associated with the inner injection nozzles 14. The outer nozzle needle 11 has a pressure shoulder 16 inside a pressure chamber 15. At the combustion chamber end, the inner nozzle needle 12 is provided with an additional pressure shoulder 18 upstream of the inner injection nozzles 14. At the end oriented away from the combustion chamber, the outer nozzle needle 11 is associated with a closing chamber 20 in which the outer nozzle needle 11 has a pressure surface 21 that is oriented toward the closing chamber and acts in the closing direction. The outer nozzle needle 11 is also associated with a damping piston 41 that is guided in a bore 42 adjoining the closing chamber 20.

A closing spring 44 in the closing chamber 20 prestresses the damping piston 41, which, inside the closing chamber 20, has an end surface 47 that is oriented toward the nozzle needle and rests against the pressure surface 21 of the outer nozzle needle 11 oriented toward the closing chamber. There is a dividing line 45 between the end surface 47 of the damping piston 41 oriented toward the nozzle needle and the pressure surface 21 of the outer nozzle needle 11. Inside a damping chamber 50, the damping piston 41 also has a pressure surface 49 embodied in the form of an annular end surface.

The inner nozzle needle 12 is connected to a control piston 43, which is embodied in the form of a piston rod and extends through the damping piston 41. In the exemplary embodiments according to FIGS. 1 through 3, a flow conduit 46 in the form of an annular gap that extends from the damping chamber 50 to the dividing line 45 is provided between the control piston 43 and the inner cylindrical wall of the damping piston 41. The control piston 43 for the inner nozzle needle 12, which piston is embodied in the form of a piston rod, extends through the damping chamber 50 and protrudes into a control chamber 53 with a pressure surface 52 at the end oriented toward the control chamber. At the transition to the control piston 43, the inner nozzle needle 12 also has a step 22 that is oriented in the closing direction of the inner nozzle needle 12 and functions as a pressure shoulder that assists the closing process of the inner nozzle needle.

From the schematically depicted high-pressure accumulator 2, fuel travels via a combined check valve/throttle valve 23 and a rail pressure line 24 into a pressure chamber 25 of the pressure booster 5. In addition to the above-mentioned pressure chamber 25, the pressure booster 5 has a differential pressure chamber 26 and a high-pressure chamber 27. The pressure booster 5 contains an axially movable stepped piston 30 that includes a first partial piston 31, which, in comparison to a second partial piston 32, has a larger, guidance-enabling diameter. The stepped piston 30 can be embodied either as two separate components or as a single component. In addition, the stepped piston 30 has a piston rod 33, which protrudes into the pressure chamber 25 and is provided with a spring retainer 34 for a closing spring 35. The end surface of the second partial piston 32 of the stepped piston 30 delimits the high-pressure chamber 27 to which a high-pressure line 36 is connected, which acts on the nozzle chamber 15 of the injection valve 9 with very highly pressurized fuel. The differential pressure chamber 26 of the pressure booster 5 has a first control line 28 and a second control line 29 branching from it; the first control line 28 is connected to the control valve 8 and, via a closing chamber throttle 54, the second control line is connected to the closing chamber 20 of the injection valve 9. The closing chamber 20 is also connected to the high-pressure line 36 via a check valve 55. The control chamber 50 is connected to the second line 29 via an outlet throttle 56. Another line 57 containing an additional throttle 58 leads from the pressure chamber 25 to the control chamber 53.

The control valve 8 is provided with a control piston 81, which has a pressure surface that delimits a control chamber 82 at its end oriented toward the control valve. A connecting conduit 83 is incorporated into the control piston 81 and connects the pressure chamber 25 to the control chamber 82 via a throttle 84. A sealing seat 78 and a control edge 85 are provided on the control piston 81. The sealing seat 78 disconnects a valve chamber 89 from a low-pressure chamber 86 that is connected to a return line 87. The return line 87 is connected to a low-pressure/return system 88. The control edge 86 disconnects the pressure chamber 25 from the valve chamber 89 into which the line 28 feeds.

The on/off valve 7 has an actuator control chamber 73 and an actuator low-pressure chamber 75; the control chamber 73 is connected to the control valve control chamber 82 via a control line 76 and the low-pressure chamber 75 is connected to the low-pressure/return system 88 via an additional return line 77.

The fuel injector 1 also has a second on/off valve 90 that has a control piston 91 that divides an actuator pressure chamber 92 from a low-pressure chamber 93. A control line 94 leads from the pressure chamber 92 to the control chamber 53. The low-pressure chamber 93 is connected to an additional return line 95 that also leads to the low-pressure/return system 88.

It is also conceivable for the second on/off valve 90 to be positioned at the top end of the fuel injector 1. For the sake of simplicity, it is also possible for it to be located outside the fuel injector 1. In this instance, the on/off valve 90 can function centrally for all of the cylinders of an internal combustion engine. In this scenario the option to use it is contingent on the number of cylinders and on the injections required since after each activation of the inner nozzle needle 12, an injection pause must occur in all cylinders in order to prevent an uncontrolled opening of the inner injection nozzles 14. An embodiment form of this kind has significant space advantages in the fuel injector 1. However, it is necessary to provide an additional hydraulic connection for the fuel injector 1. An external on/off valve 90 must also have sufficient dynamics to achieve an activation during an injection pause. The operating pressure can conceivably be the rail pressure or a defined low pressure of for example 5 to 50 bar. This consequently requires a corresponding design of the pressure surface 52 in the control chamber 53. When pressures on the order of roughly 5 bar are used, the second on/off valve 90 can be embodied in the form of a low-pressure on/off valve. In all variants, the injection nozzles 13, 14 and the damping chamber 50 are subjected to pressure. Prevention of leakage via the guide surfaces between the inner and the outer nozzle needles 11, 12 requires selection from among the intrinsically known measures, e.g. a double needle seat on the outer nozzle needle 11 or an additional leakage drain between the nozzle needles 11, 12.

In a normal state in which the injection nozzles 13, 14 are closed by the outer and inner nozzle needles 11, 12, all of the pressure chambers in the pressure booster 5 are subjected to rail or system pressure. The stepped piston 30 is thus pressure balanced. In this state, the pressure booster 5 is deactivated; the return spring 35 has returned the stepped piston 30 to its starting position and the pressure chamber 25 has been filled via the check valve 23. In the normal state, rail or system pressure prevails in the closing chamber 20, the damping chamber 50, and the control chamber 53. Because of the area ratios of the end surfaces 49, 52 and the pressure shoulders 16, 18 embodied on the nozzle needles 11, 12, a hydraulic closing pressure acts on the inner and outer nozzle needles 11, 12. The compression spring 44 acting on the damping piston 41 and therefore on the outer nozzle needle 11 also assists the closing process. As a result, the rail pressure can be present in the nozzle chamber 15 on a constant basis without causing the outer nozzle needle 11 to open.

In order to cause the outer nozzle needle 11 to open, the pressure in the nozzle chamber 15 must rise above the rail pressure, which is achieved by switching on the pressure booster 5. This is initiated, as shown in FIGS. 1 through 4, by a depressurization of the differential pressure chamber 26 through activation of the electromagnet of the on/off valve 7, which causes a depressurization of the control valve control chamber 82 into the low-pressure/return system via the actuator control chamber 73 and the actuator low-pressure chamber 75. This causes the control piston 81 of the control valve 8 to lift, as a result of which the control edge 85 closes the connection to the pressure chamber 25. At the same time, a connection is opened up between the valve chamber 89 and the low-pressure chamber 86, as shown in FIGS. 1 through 4. As a result, the differential pressure chamber 26 is connected to the low-pressure/return system 88 via the line 28. The pressure in the differential pressure chamber 26 decreases, as a result of which the pressure booster 5 is activated and the partial piston 32 of the stepped piston 30 compresses the fuel in the high-pressure chamber 27. The compressed fuel travels via the high-pressure line 36 into the nozzle chamber 15. At the same time, the pressure in the closing chamber 20 is relieved via the closing chamber throttle 54 so that the action of the high-pressure on the pressure shoulder 16 causes the outer nozzle needle 11 to lift up, as shown, as a result of which the injection via the outer injection nozzles 13 begins. Due to the resulting upward movement of the outer nozzle needle 11, the end surface 49 of the damping piston 51 compresses a volume in the damping chamber 50; the compressed fuel can flow out of the damping chamber 50 via the outlet throttle 56 into the unpressurized line 29. The outlet throttle 56 has a more powerful throttle action than the closing chamber throttle 54 so that the damping piston 41 can execute a damping action in the damping chamber 50. The opening speed of the outer nozzle needle 11 and therefore the injection rate can be determined through a suitable dimensioning of the outlet throttle 56 and the closing chamber throttle 54.

The motor control unit, not shown, then actuates the additional on/off valve 90 and the control chamber 53 is connected to the low-pressure/return system 88 via the actuator pressure chamber 92 and the low-pressure chamber 93. Due to the throttle 58 provided in the line 57 in the exemplary embodiment according to FIG. 1, less replenishing fuel flows out of the pressure chamber 25 so that the pressure is relieved in the control chamber 53 and as a result, the inner nozzle needle 12 lifts away from the inner injection nozzles 14. The separate actuation of the first on/off valve 7 and the second on/off valve 90 also makes it possible, by implementing a corresponding actuation, to open only the outer nozzle needle 11, to open the outer nozzle needle 11 and the inner nozzle needle 12 in sequence, or to open both nozzle needles 11, 12 simultaneously, in order to thus achieve different injection rates. This permits a flexible injection at various pressures and injection angles and consequently makes it possible to implement an optimum adaptation to various combustion concepts in the engine.

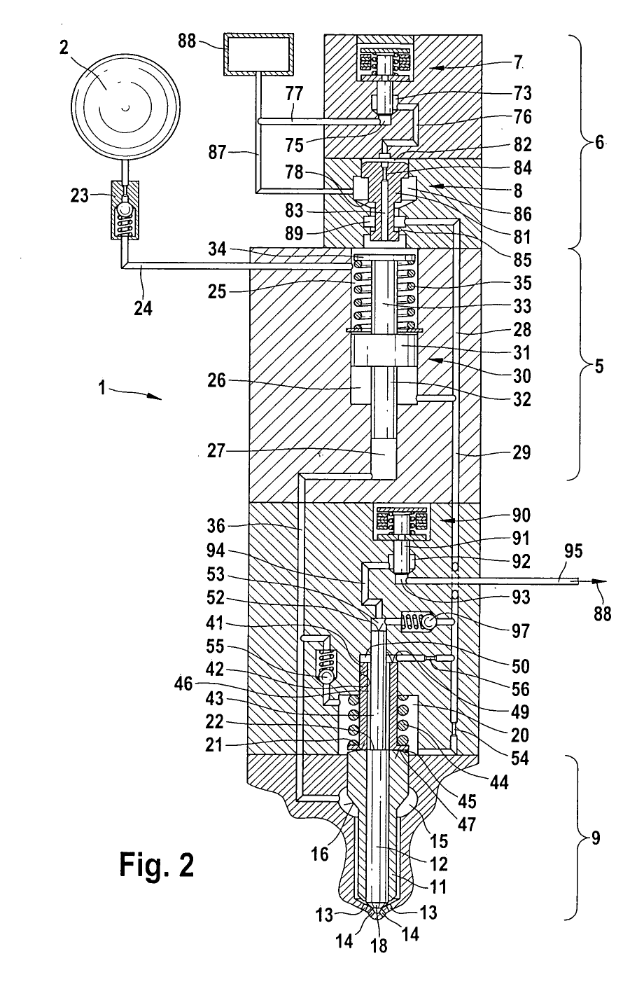

In the exemplary embodiments shown in the remaining figures, components that are the same are provided with the same reference numerals. In the exemplary embodiment shown in FIG. 2, the control chamber 53 for the inner nozzle needle 12 is not connected to the pressure chamber 25 of the pressure booster 5, but is instead connected to the control line 29 via a check valve 97. The check valve 97 functions in opposition to the emptying direction leading from the control chamber 53 so that the check valve 97 only permits a filling of the control chamber 53 from the control line 29. An actuation of the second on/off valve 90 causes the inner nozzle needle 12 to open, as has been described in conjunction with FIG. 1.

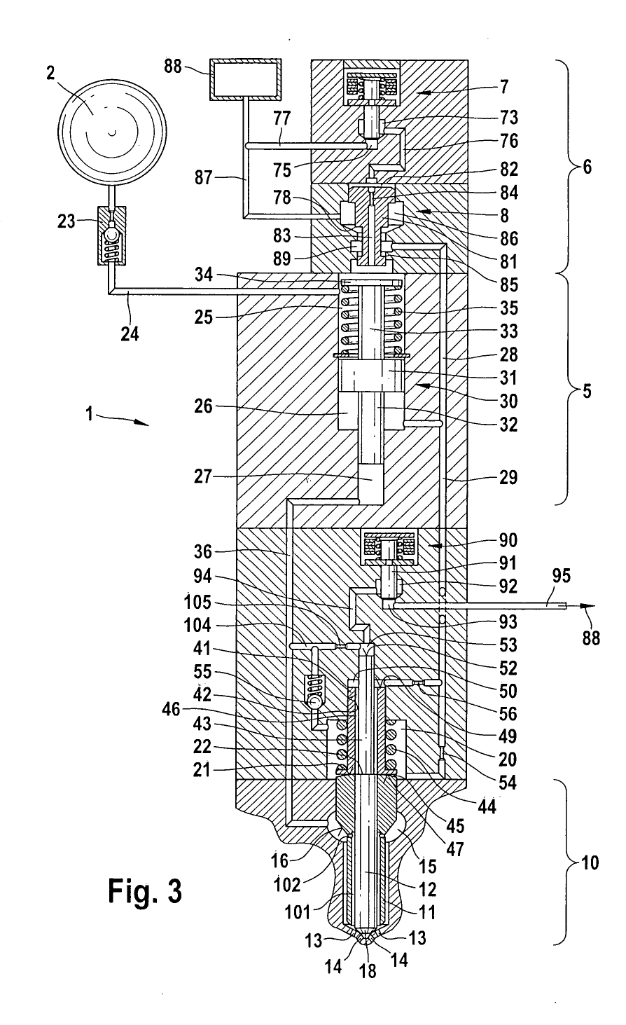

In the exemplary embodiment in FIG. 3, a fuel injector 1 has an injection valve 10 equipped with a vario-nozzle in which the inner injection nozzles 14 are supplied with fuel via a separate fuel supply 101. For example, the separate fuel supply is embodied in the form of an intermediate chamber or an annular gap between the inner nozzle needle 12 and the outer nozzle needle 11. In addition, a connecting conduit 102 is routed, for example radially, through the outer nozzle needle 11 and connects the nozzle chamber 15 to the fuel supply 101 so that the injection pressure prevailing in the nozzle chamber 15 also prevails against the pressure shoulder 18 of the inner nozzle needle 12 at the combustion chamber end. This embodiment produces an intrinsically known leakless vario-nozzle in which the outer nozzle needle 11 is provided with a double seat, not shown, that functions as a sealing seat at the combustion chamber end. As in the exemplary embodiments 1 and 2, the activation of the outer nozzle needle 11 is initiated by means of the first on/off valve 7 with the interposition of the pressure boosting unit 5. Here, too, the opening of the outer nozzle needle 11 is damped by means of the damping piston 41. In the exemplary embodiment in FIG. 3, the control chamber 53 is connected to the high-pressure line 36 via a hydraulic connection 104 that contains a throttle 105. A connection via the check valve 55 to the closing chamber 20 is also provided for the filling of the control chamber 52. As a result, in the depressurized state, the control chamber 53 is coupled to the rail pressure via the closing chamber 20. Through additional actuation of the second on/off valve 90, the row of holes of the inner injection nozzles 14 can be opened and closed at any time. In this exemplary embodiment, the separate fuel supply for the inner injection nozzles 14 makes it possible to use a separate actuation of the inner nozzle needle 12 to execute a stroke-controlled injection at rail pressure without the interposition of the pressure boosting unit 5. This permits short injection intervals and an advantageous multiple injection due to low pressure fluctuations. In combination with a slight inclination of the bores for the injection nozzles 14, it is possible to achieve an early injection with a homogeneous combustion.

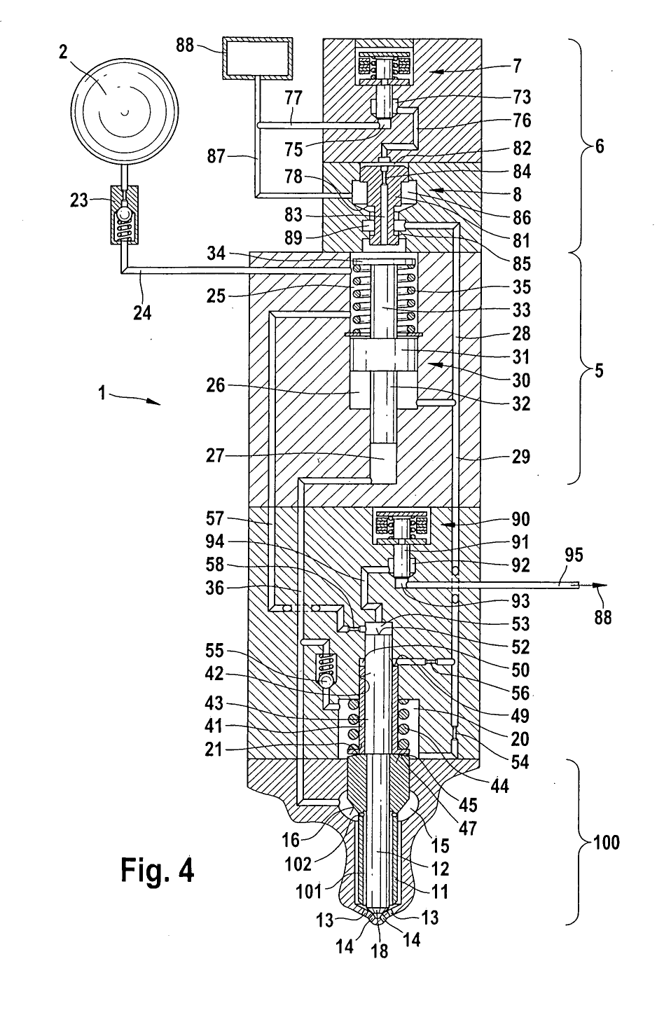

The exemplary embodiment according to FIG. 4 uses an injection valve 100 likewise equipped with a leakless vario-nozzle. As in the exemplary embodiment according to FIG. 3, the inner injection nozzles 14 are provided with a separate fuel supply 101 between the inner and outer nozzle needles 11, 12 and via the connecting conduit 102. In this exemplary embodiment, though, the control chamber 53 is not connected to the high-pressure line 36, but—as in the exemplary embodiments according to FIGS. 1 and 2—is connected via the line 57 and the throttle 58 to the pressure chamber 25 of the pressure boosting unit 5. As a result, the control chamber 53 is coupled to the rail pressure prevailing in the pressure chamber 25. Also in contrast with the exemplary embodiment of the leakless vario-nozzle in FIG. 3, there is no hydraulic connection between the damping chamber 50 and the closing chamber 20. In this exemplary embodiment, the closing of the outer nozzle needle 11 is achieved merely by means of the pressure surface 21, assisted by the compression spring 44. Here, too, the inner nozzle needle 12 is actuated by means of the second on/off valve 90. With an adapted pressure surface 52, this embodiment form permits the use of an injection valve with low requirements regarding its capacity to resist high-pressure leaks and withstand high-pressure strains.

It is also conceivable to use the actuation of the vario-nozzles 10, 100 described in FIGS. 1 through 4 without a pressure booster 5.

The foregoing relates to preferred exemplary embodiments of the invention, it being understood that other variants and embodiments thereof are possible within the spirit and scope of the invention, the latter being defined by the appended claims.

1. In a fuel injection apparatus for internal combustion engines, having a fuel injector that can be fed by a high-pressure fuel source and is equipped with an injection valve that has injection nozzles oriented toward the combustion chamber; the injection nozzles are associated with an inner nozzle needle and an outer nozzle needle guided coaxial to the inner one, which needles can be actuated to open and close injection cross sections at the injection nozzles; the outer nozzle needle is associated with a damping piston and the inner nozzle needle is associated with a control piston, which pistons are guided one inside the other in such a way that they can move in relation to each other; the damping piston of the outer nozzle needle acts on a damping chamber and the control piston of the inner nozzle needle acts on a first control chamber; a pressure surface of the outer nozzle needle is associated with a closing chamber; and a first on/off valve is provided that actuates the outer nozzle needle by connecting the closing chamber to a low-pressure/return system, the improvement comprising an additional on/off valve (90) operable to actuate the inner nozzle needle (12) and to connect a control chamber (53) for the inner nozzle needle (12) to the low-pressure/return system (88).

2. The fuel injection apparatus according to claim 1, wherein the control chamber (53) is filled by being connected to a rail pressure line via a throttle (58).

3. The injection apparatus according to claim 1, wherein the control chamber (53) is filled by being connected via a check valve (97) to a control line (29) that can be connected to the low-pressure/return system (88); and wherein the check valve (97) prevents the control chamber (53) from emptying into the control line (29).

4. The fuel injection apparatus according to claim 1, wherein the inner injection nozzles (14) are provided with a separate fuel supply line (101) that leads to a pressure shoulder (18) on the inner nozzle needle (12) situated upstream of the injection nozzles (14).

5. The fuel injection apparatus according to claim 4, wherein the control chamber (53) for the inner nozzle needle (12) is connected to a rail pressure line via a throttle (58).

6. The fuel injection apparatus according to claim 4, wherein the control chamber (53) for the inner nozzle needle (12) is connected to a high-pressure line (36) of a pressure boosting unit (5) via a throttle (105).

7. The fuel injection apparatus according to claim 4, wherein the fuel supply line (101) comprises of an intermediate chamber between the inner nozzle needle (12) and the outer nozzle needle (11) and leads via a connecting conduit (102) into a nozzle chamber (15) that acts on a pressure shoulder (16) of the outer nozzle needle (11).

8. The fuel injection apparatus according to claim 5, wherein the fuel supply line (101) comprises of an intermediate chamber between the inner nozzle needle (12) and the outer nozzle needle (11) and leads via a connecting conduit (102) into a nozzle chamber (15) that acts on a pressure shoulder (16) of the outer nozzle needle (11).

9. The fuel injection apparatus according to claim 6, wherein the fuel supply line (101) comprises of an intermediate chamber between the inner nozzle needle (12) and the outer nozzle needle (11) and leads via a connecting conduit (102) into a nozzle chamber (15) that acts on a pressure shoulder (16) of the outer nozzle needle (11).

10. The fuel injection apparatus according to claim 1, further comprising a pressure surface (21) of the outer nozzle needle (11) associated with the closing chamber (20), the pressure surface (21) being situated at a dividing line (45) between the damping piston (41) and the outer nozzle needle (11).

11. The fuel injection apparatus according to claim 2, further comprising a pressure surface (21) of the outer nozzle needle (11) associated with the closing chamber (20), the pressure surface (21) being situated at a dividing line (45) between the damping piston (41) and the outer nozzle needle (11).

12. The fuel injection apparatus according to claim 3, further comprising a pressure surface (21) of the outer nozzle needle (11) associated with the closing chamber (20), the pressure surface (21) being situated at a dividing line (45) between the damping piston (41) and the outer nozzle needle (11).

13. The fuel injection apparatus according to claim 4, further comprising a pressure surface (21) of the outer nozzle needle (11) associated with the closing chamber (20), the pressure surface (21) being situated at a dividing line (45) between the damping piston (41) and the outer nozzle needle (11).

14. The fuel injection apparatus according to claim 5, further comprising a pressure surface (21) of the outer nozzle needle (11) associated with the closing chamber (20), the pressure surface (21) being situated at a dividing line (45) between the damping piston (41) and the outer nozzle needle (11).

15. The fuel injection apparatus according to claim 6, further comprising a pressure surface (21) of the outer nozzle needle (11) associated with the closing chamber (20), the pressure surface (21) being situated at a dividing line (45) between the damping piston (41) and the outer nozzle needle (11).

16. The fuel injection apparatus according to claim 7, further comprising a pressure surface (21) of the outer nozzle needle (11) associated with the closing chamber (20), the pressure surface (21) being situated at a dividing line (45) between the damping piston (41) and the outer nozzle needle (11).

17. The fuel injection apparatus according to claim 1, further comprising a pressure boosting unit (5) with a differential pressure chamber (26) which can be connected to the low-pressure/return system (88), the damping chamber (50) of the outer nozzle needle (11) being connected to the differential pressure chamber (26) via the outlet throttle (56).

18. The fuel injection apparatus according to claim 2, further comprising a pressure boosting unit (5) with a differential pressure chamber (26) which can be connected to the low-pressure/return system (88), the damping chamber (50) of the outer nozzle needle (11) being connected to the differential pressure chamber (26) via the outlet throttle (56).

19. The fuel injection apparatus according to claim 3, further comprising a pressure boosting unit (5) with a differential pressure chamber (26) which can be connected to the low-pressure/return system (88), the damping chamber (50) of the outer nozzle needle (11) being connected to the differential pressure chamber (26) via the outlet throttle (56).

20. The fuel injection apparatus according to claim 4, further comprising a pressure boosting unit (5) with a differential pressure chamber (26) which can be connected to the low-pressure/return system (88), the damping chamber (50) of the outer nozzle needle (11) being connected to the differential pressure chamber (26) via the outlet throttle (56).
